(19) United States
(12) Patent Application Publication
(10) Pub. No.: US 2008/0035433 A1
(43) Pub. Date: Feb. 14, 2008

(54) Hydraulic integrated parking brake system

(76) Inventors: Steven Strand, Coon Rapids, MN (US); David Anderson, Plymouth, MN (US)

Correspondence Address: PARKER-HANNIFIN CORPORATION;HUNTER MOLNAR BAKER MORGAN, 6035 PARKLAND BOULEVARD, CLEVELAND, OH, 44124-4141, US

(21) Appl. No.: 11/451,948

(22) Filed: Jun. 13, 2006

Related U.S. Application Data
(60) Provisional application No. 60/689,865, filed on Jun. 13, 2005.

(51) Int. Cl. F16D 55/18; G01B 7/14; G05G 1/04

(52) U.S. Cl. 188/72.4; 324/207.2; 74/519

(57) ABSTRACT

A parking brake system for a vehicle with wheel brakes, the system, normally applied, including a main housing having interconnected cavities and bores; a hydraulic pump in one housing cavity, an electric motor for driving the pump and producing pressurized fluid, an internally preloaded actuator having an axially movable output member, mounted in another housing cavity and hydraulically connected with the one cavity, a Hall-Effect sensor with a built-in relay for controlling the motor mounted in a housing bore, a normally-open control valve connected with the another cavity, a piston in another cavity mechanically interconnected with the actuator/output member.

### CROSS REFERENCE TO RELATED APPLICATIONS

The present application claims the benefit of the filing date of U.S. Provisional Patent Application Ser. No. 60/689,865, filed Jun. 13, 2005, the disclosure of which is incorporated herein by reference.

### FIELD OF THE INVENTION

The present invention relates to a hydraulic parking brake system for use on vehicles with wheel brakes. The parking brake system is normally applied and is disengaged via hydraulic pressure acting on a piston in opposition to a preloaded actuator.

### BACKGROUND OF THE INVENTION

Parking brake systems are well known in the art and are most commonly used on wheeled vehicles in a manually operated manner wherein the operator, generally via hand or foot operation, activates a cable or linkage that in turn physically applies a stationary brake member into engagement with a brake component that normally rotates with or relative to a vehicle wheel, thus arresting the latter.

Fail-safe parking brake systems include mechanisms that normally bias these mechanisms to the applied position and it is necessary to specifically override these mechanisms in order to be able to move the vehicles. Such mechanisms are often cumbersome, bulky, expensive and difficult to install, particularly in retrofit types of installations.

### SUMMARY OF THE INVENTION

Accordingly, in order to overcome the deficiencies of the prior art devices, the present invention provides a Hydraulic Integral Parking Brake System Package (HIPBSP) for vehicles, such as fork-lift trucks that can easily be installed as integrated units in any desired position. This construction which requires no external wiring minimizes installation space requirements and cost. Also provided is an emergency manual disengagement option.

Specifically, the present invention in one embodiment relates to a parking brake system for a vehicle which includes wheel brakes with the parking brake system being normally applied under the control of a preloaded actuator, the parking brake system comprises: a main housing having a plurality of interconnected cavities and bores as well as an integral a source of hydraulic fluid; a hydraulic pump secured in and submerged within a first cavity of the main housing; an electric motor, connected with a source of applicable electric power, attached to the main housing, at the first cavity, and operatively interconnected with the hydraulic pump for providing pressurized hydraulic fluid; the preloaded actuator including a movable output member, secured to a second cavity of the main housing and being hydraulically interconnected with the hydraulic pump; the main housing further including, in a bore portion thereof, a Hall-Effect sensor with a built-in relay for controlling the electric motor; a normally open control valve operatively connected with the second cavity and a reservoir; a first piston, located in the second cavity, mechanically interconnected with the preloaded actuator and its output member, and hydraulically interconnected with the hydraulic pump; during a release of the parking brake system the first piston being axially displaced via hydraulic pressure and moving against the preload of the actuator; the Hall-Effect sensor detecting the presence of the first piston at the top of its stroke controlling the delivery of electric power to the electric motor.

One version of the parking brake system further includes an emergency release mechanism. In the event of the absence of electrical power, the release mechanism including a release member retained in an aperture in the main housing with an inner end of the release member abutting a bottom surface of the first piston; and an outer end of the release member extending axially outwardly from the aperture and being provided with a tool-application portion for permitting manual rotation of the release member to axially displace the first piston in opposition to the preload of the actuator, thereby releasing the parking brake system.

In another version of the parking brake system, the preloaded actuator takes the form of a strut assembly having an internal compression spring preloaded to a predetermined value. In a variation thereof, the strut assembly output member axially extends from both ends thereof, with an output member outer end being provided with adjustment and jam nuts as well as an attachment member for operative mechanical interconnection with the wheel brakes. In another variation thereof, an inner end of the output member includes a stepped portion that terminates within the first piston.

In a further version of the parking brake system, the axial movement of the first piston, and consequently of the actuator output member, is sufficient, depending upon the direction of movement thereof, to one of apply and release the parking brake system.

A differing version of the parking brake system further includes, within the main housing and within the pluralities of bores, a relief valve and a check valve, both located downstream of the hydraulic pump.

In still another version of the parking brake system, the location of the Hall-Effect sensor with its built-in relay, within the main housing is axially spaced from an at-rest position of the first piston at a distance substantially corresponding with a predetermined length of axial movement of the first annular piston.

An additional version of the parking brake system further includes a steel ring interposed between an inner end surface of the second cavity and the first piston.

In yet another version of the parking brake system the specific vehicle to which the system is applied is a fork-lift truck.

In a yet differing version, the preloaded actuator includes: a spring cylinder having a fully open lower end, a constricted upper end and an intermediate cavity; the movable output member extending from both ends thereof; the lower end being closed by a stepped annular cap; a second piston located within the cavity; and a compression spring, located within the cavity between an inner surface of the second piston and an inner surface of the spring cylinder constricted upper end. In one variation thereof, the compression spring is preloaded to a predetermined value, depending upon the specific application of the parking brake system. In another variation thereof, the first and second pistons are of differing diameters. In this variation, the main housing second cavity is stepped and includes a smaller diameter inner bore, for housing the first piston, and a larger diameter outer bore, for housing the second piston. A yet differing variation thereof, further including a bushing located intermediate the first and second pistons.

In still another version, the normally-open control valve is a rotary solenoid operated valve. In another version, the built-in relay of the Hall-Effect sensor includes bladed terminals.

### DESCRIPTION OF THE DRAWINGS

FIG. 1 is a perspective view of the parking brake system of the present invention.

FIG. 2 is an elevational view of one side of the parking brake system of this invention.

FIG. 3 is an enlarged sectional view, taken along line 3-3 of FIG. 2.

FIG. 4 is an elevational view of the side of the parking brake system opposite to that of Fig.

FIG. 5 is an elevational view of one end of the parking brake system of this invention.

FIG. 6 is an enlarged sectional view taken along line 6-6 of FIG. 3.

FIG. 7 is a hydraulic schematic of the parking brake system of this invention.

FIG. 8 is an electrical schematic of the parking brake system of this invention.

FIG. 9 is a top plan view, with parts broken away and partly in section, of a generic industrial vehicle, such as a fork lift truck, incorporating the parking brake system of this invention.

### DETAILED DESCRIPTION OF THE INVENTION

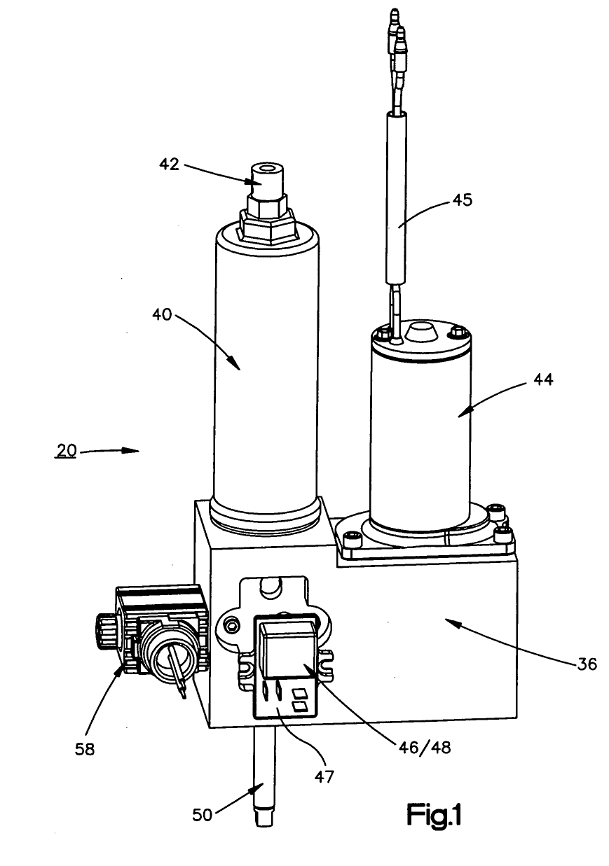

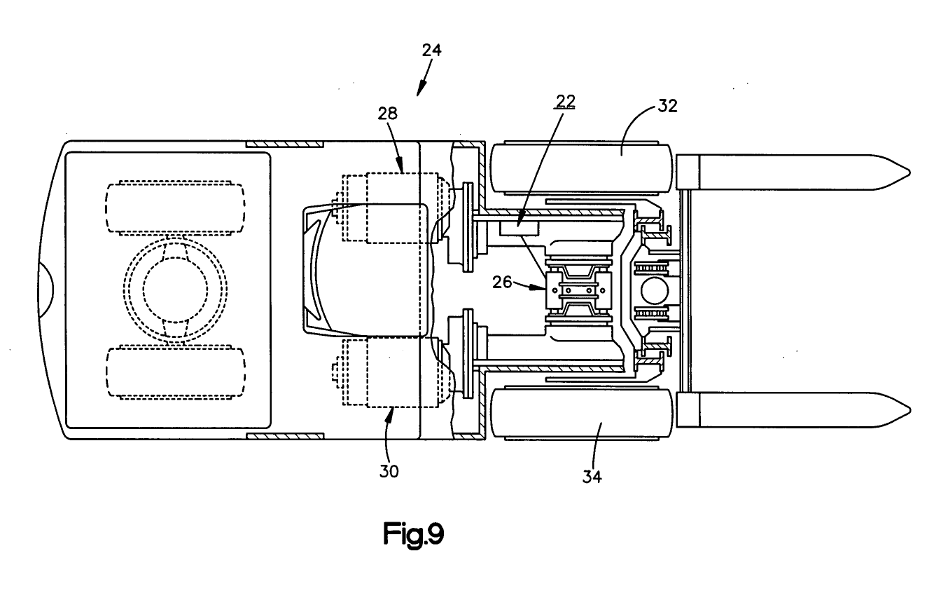

Illustrated in the perspective view of FIG. 1 is a complete hydraulically operated parking brake system 20 which is utilized, for example, in at least one particular application, as a parking brake system 22 of a forklift 24 (FIG. 9) In FIG. 9, any desired, brake assembly 26, interposed between motor-driven transmissions 28, 30 acts on driven, opposed, front wheels 32, 34 in a manner known in the art. It is an objective of this invention to provide a complete integral hydraulic parking brake system, such as that shown by reference number 20 that can be easily installed to function as a parking brake system 22.

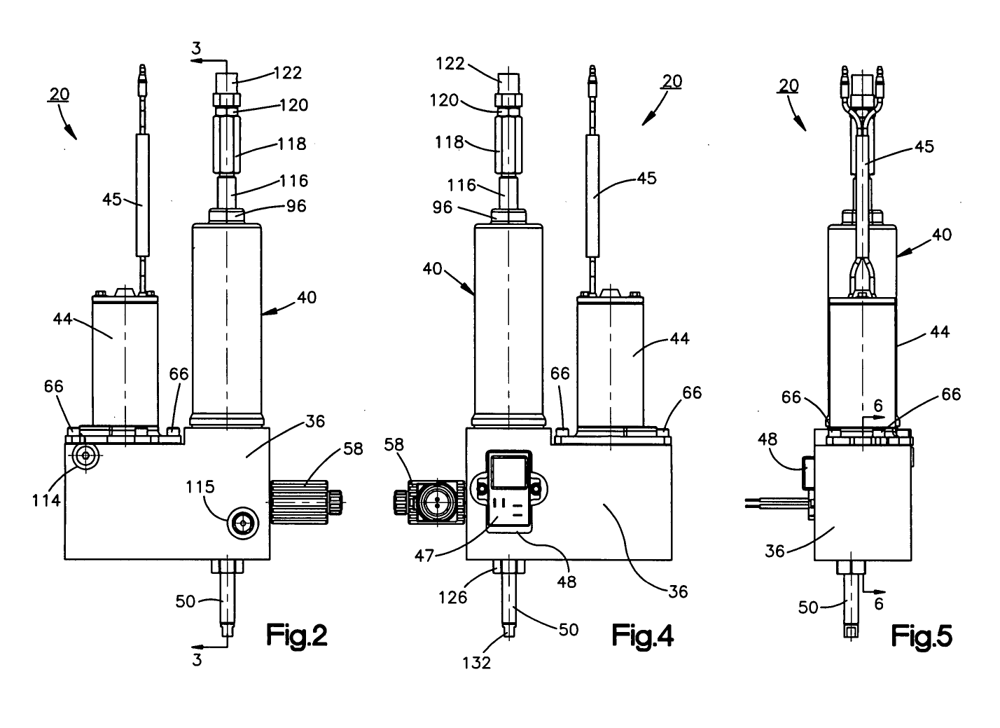

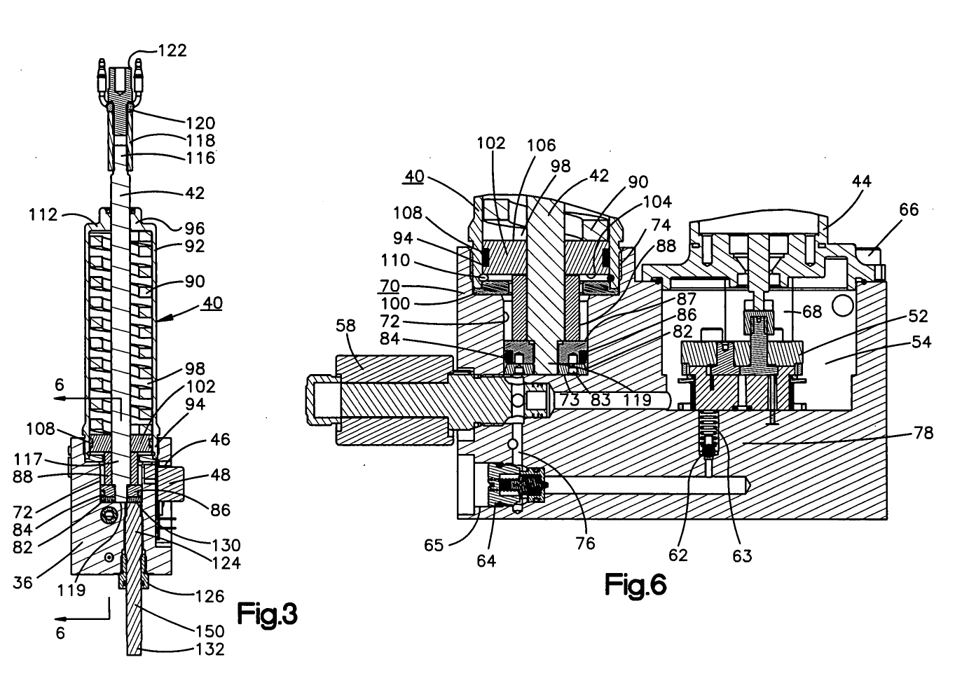

Returning briefly to the FIG. 1, as well as turning to FIGS. 2, 4 and 5, illustrated therein is parking brake system 20 which includes a main housing or block 36. Attached to the main housing 36 is an actuator or application cylinder, such as spring-loaded cylinder 40, with an application member 42, a preferably 12 volt D.C. rotatable electric motor 44 with an electrical lead-in 45, a Hall-Effect sensor or sensor module 46 with a built-in relay 48 and a manual release member, such as a threaded rod 50. Thus, the parking brake system 20 is an integrated package. As best seen in FIG. 6, secured and submerged within a main housing first cavity 54, is a hydraulic gear pump 52. FIG. 6 also shows the placement of a normally open solenoid controlled or operated valve 58 mounted within a stepped bore 60 that is operatively connected with first cavity 54. A relief valve 64 and a check valve 62 are located downstream of hydraulic pump 52 in bores 63 and 65, respectively. Normally-open control valve 58 is used to release the hydraulic pressure within as well as activate the parking brake system 20 in a manner to be described in more detail hereinafter.

As best seen in FIGS. 4, 5 and 6, electric motor 44, is bolted to main housing 36 via a plurality of retaining bolts 66 and is operatively interconnected with and drives hydraulic pump 52 via a coupling member 68 (FIG. 6). While 12 volt DC use is currently preferred, voltage ranges from about 12 to 42 are readily envisioned, depending upon application. Main housing 36 is also provided with a second, stepped, housing cavity 70 having a smaller diameter inner bore portion 72 and a larger diameter outer bore portion 74. The bottom surface 73 of inner bore portion 72 is operatively interconnected with stepped bore 65 and check valve 62 via a connecting passage or bore 76, with stepped bore 65 also being operatively interconnected with the output portion of hydraulic pump 52 via a connecting bore or passage 78.

Located within second cavity inner bore portion 72, at a bottom surface 73 thereof, are an inner steel ring 82 and an abutting, stepped, inner annular piston 86, the latter cradling a peripheral seal member 84 therebetween. Adjoining an upper surface 87 of piston 86 is a bushing 88 of a length sufficient to enter second cavity outer bore portion 74. Fixedly secured in cavity 74 is the lower end 94 of application cylinder 40 which, for example, may take the form of a commercial strut assembly. Strut assembly 40 utilizes a preloaded compression spring 90 confined within a spring cylinder 92 having a fully open lower end 94 and a constricted upper end 96 with application member or rod 42 extending from both ends thereof as best illustrated in FIG. 3.

As best seen in FIG. 6, strut assembly lower end 94 is closed by a stepped annular cap 100 with bushing 88 extending therethrough and into the lower end of strut cavity 98 and abutting the lower surface 104 of an annular strut piston 102 which is provided with a peripheral lathe cut ring 108 for sealing purposes. Strut piston 102 is retained within strut cavity 98 via a steel retaining ring 110 located within a groove in the inner surface of spring cylinder 92. Also located within strut cavity 98 is compression spring 90 that is preloaded to a predetermined amount, depending upon the specific application. In one operative example, the preload of compression spring 90 is 900 pounds, with spring 90 being confined between strut piston upper surface 106 and an inner surface 112 of spring cylinder constricted upper end 96.

As shown in FIGS. 2, 3 and 4, the stepped outer end 116 of application rod 94 extends through strut assembly upper end 96 and is provided with an adjustment nut 118, a jam nut 120 and an attachment member 122 for a cable and/or rod, etc. (neither shown) extending to and operatively connected with brake assembly 26. A lower end 117 of application rod 42 extends from strut assembly 40 through bushing 88 and includes a stepped end portion 119 (FIG. 3) terminating in annular inner piston 86 and inner steel ring 82. Also illustrated in FIG. 3 is that manual release member 50 is retained in a stepped aperture 124 in main housing or block 36, in a threaded relationship therewith, via an apertured hex plug 126, with an inner end 130 of release member 50 abutting a bottom surface 83 of steel ring 82 in cavity portion 72. An outer end 132 of release member 50 is preferably provided with a hexagonal external shape for tool-application purposes which will be explained later.

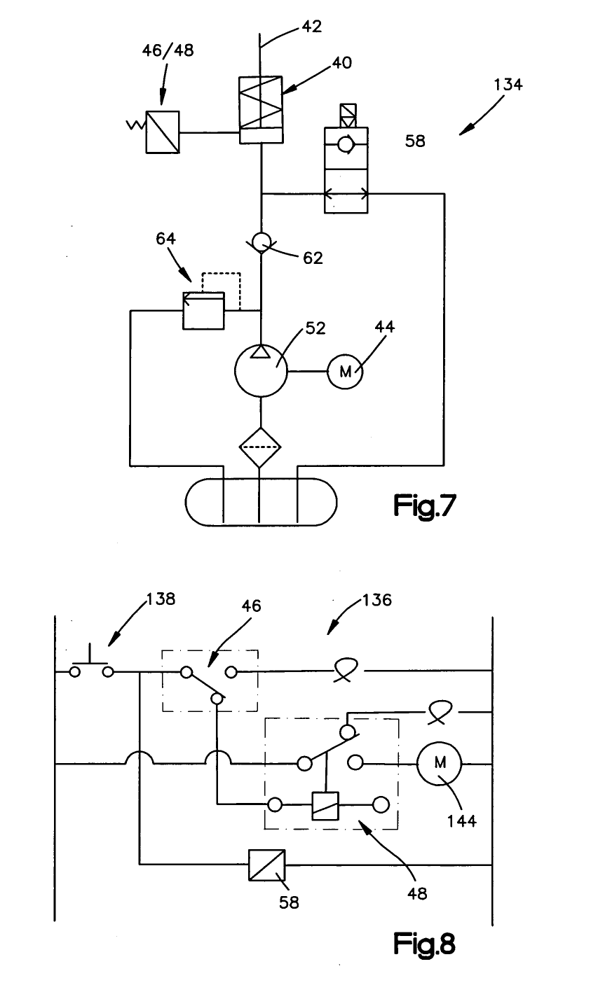

Prior to describing the operation of the parking brake system 20, attention is first directed to the hydraulic schematic 134 of FIG. 7 and the electrical schematic 136 of FIG. 8. Schematic 134 illustrates that electric motor 44 and hydraulic gear pump 52 operate, in unison and in one direction, for pumping hydraulic fluid into strut cylinder 40, with relief valve 64 limiting the amount of fluid pressure in order to avoid damaging the other hydraulic components. In-line check valve 62 serves to eliminate hydraulic fluid leakage through pump 52. Normally open solenoid-operated valve 58 controls the flow of hydraulic fluid by switching valve 58 open or closed, this function being initiated by the operator. Hall-Effect sensor 46 (FIG. 3) and its integral relay 48 turn off electric motor 44 when stepped inner piston 86 (FIG. 3) has reached the top end of its stroke. Plugs 114, 115 (FIG. 2), serve to temporarily close off associated respective ports connected with integral reservoir in main housing cavity 54.

Electrical schematic 136, illustrated in FIG. 8, shows that the operator must activate panel switch 138 in order to initiate the operation of parking brake system 20. If so desired, the operation of parking brake system 20 may also be initiated, for example by being wired to a transmission control circuit which will activate system 20 when the transmission is shifted into a “Park” position, or, in another alternative, operation could be initiated by being wired to a load cell in the operator's seat cushion so as to activate system 20 whenever the operator leaves his seat. As indicated in schematic 136, the electrical connection from the vehicle to parking brake system 20 can easily be attached via the Hall-Effect sensor/relay bladed terminal 47 shown in FIGS. 1 and 4. Furthermore, it should be evident that different combinations of switching parking brake system 20 on and off can be accomplished very easily.

Turning now to the description of the actual operation parking brake system 20, it must be initially clear that the vehicle is in “park” mode and that system 20 has already been engaged. Thus, once the system 20 has been engaged, the operator applies electric power, via a switch, so as to disengage the system 20 from its “parked” position as follows:

The operator activates panel switch 138 (FIG. 8), causing motor/pump combination 44/52 to start operation so as to build up hydraulic pressure in strut assembly 40, thereby extending strut piston 102 (acting via inner piston 86 and bushing 88) against the opposing force of preloaded spring 90 in cylinder or strut assembly 40. Electric power to motor/pump combination 44/52 is automatically shut off when Hall-Effect sensor 46 (FIG. 3) detects the presence of inner piston 86 at the top of its stroke. Relay 48 is then deactivated and shuts off the delivery of electric power to electric motor 44. The hydraulic pressure, built-up within strut assembly 40, keeps strut piston 102 in place against the opposing force of compression spring 90. At this time, parking brake system 20 is no longer applied and the vehicle can now be moved, if so desired. The operator sets or applies the system 20 by activating panel switch 138, thereby causing normally-open solenoid-controlled valve 58 to release the hydraulic pressure within strut assembly 40, thereby causing spring 40 to apply force to vehicle brake(s) 26 in the manner already described.

It should be understood, at this time that electric power is used to release the system 20, once applied; otherwise vehicle 24 cannot be moved. In case of a power failure, such as the unavailability of battery power, an emergency manual release of the system 20 can be achieved by manually turning threaded release rod 50, at hex end 132, thereby axially displacing steel ring 82 which, in turn, further compresses spring 90 and axially displaces application rod 42.

The parking brake system 20 can be secured to the frame of a vehicle (FIG. 9), such as a fork-lift truck 24, so that its brake cable or rod (neither shown per se) can be easily attached. System 20, or system 22 in the specific case of a lift truck, can be mounted in vertical, horizontal or intermediate positions, depending on the best scenario for linking same to the fork-lift truck's brake cable/rod. The force of spring-loaded cylinder 40 in systems 20 and 22 “parks” vehicle 24 by pulling the brake cable/rod. Systems 20/22 counteract the preload of mechanical spring 90 by generating the hydraulic force that is necessary to disengage spring 90 from its “parked” position. Looking at it in another way, the parking brake is normally applied, via spring 90, unless overridden by the hydraulic force generated by motor/pump combination 44/52 and can thus be denominated as a “fail-safe” system. An emergency parking brake release can be accomplished by manual rotation of release member 50 in the manner previously described, and can be used in case of electrical power failure in vehicle 24 if the latter must be moved before electrical power can be restored. The strategic placement of Hall-Effect sensor 46, as previously described, uses the magnetic field principles thereof to detect when lower piston 86 reaches the top of its stroke. As already noted, Hall-Effect sensor 46 utilizes a built-in relay 48 for providing the electrical connection with electric motor 44.

The unique design and structural attributes of the present invention include the completely integrated system that can be utilized in a turn-key manner and installed as a completely self-contained unit. Second, Hall-Effect sensor 46 with a built-in relay 48 and a solenoid operated control valve 58, are assembled into one main housing or block 36 with the other components of the system 20. Hall-Effect sensor 46 has relay 48 built into its module for simplicity, ease of installation and cost efficiency. By introducing the sensor/relay module 46/48, no external wiring is required; the space requirement therefore is reduced to a minimum and it allows easy wiring with reference to the lift truck power source and the panel switch. Thirdly, systems 20, 22, are complete, unitary packages that are ready for installation and can be mounted, at any desired spatial attitude in a vehicle frame for achieving an easy conversion, among other things, from an existing manual system to a fully hydraulic system while allowing the end user to determine an optimal location fit for the joining same to the existing brake cable/rod. Finally, the previously-discussed emergency release option, via release rod 50, in case of a vehicle electrical power failure, permits release of systems 20 and 22, if so desired.

It is deemed that one of ordinary skill in the art will readily recognize that the several embodiments of the present invention fill remaining needs in this art and will be able to affect various changes, substitutions of equivalents and various other aspects of the invention as described herein. Thus, it is intended that the protection granted hereon be limited only by the scope of the appended claims and their equivalents.

What is claimed is:

1. A parking brake system for a vehicle which includes wheel brakes, with said parking brake system being normally always applied under the control of a preloaded actuator, said parking brake system including:
a main housing having a plurality of interconnected cavities and bores as well as an integral source of hydraulic fluid;
a hydraulic pump secured in and submerged within a first cavity of said main housing;
an electric motor, connected with a source of applicable electric power, attached to said main housing, at said first cavity, and operatively interconnected with said hydraulic pump for providing pressurized hydraulic fluid;
said preloaded actuator including a movable output member, secured to a second cavity of said main housing and being hydraulically interconnected with said hydraulic pump;
said main housing further including, in a bore portion thereof, a Hall-Effect sensor with a built-in relay for controlling said electric motor;
a normally open control valve operatively connected with said second cavity and a reservoir;
a first piston, located in said second cavity, mechanically interconnected with said preloaded actuator and its output member, and hydraulically interconnected with said hydraulic pump;
during release of said parking brake system, said first piston being axially displaced via said hydraulic pressure and moving against the preload of said actuator; said Hall-Effect sensor detecting the presence of said first piston at the top of its stroke and controlling the delivery of electric power to said electric motor.

2. The parking brake system of claim 1, further including an emergency release mechanism, said emergency release mechanism including a release member retained in said main housing with an inner end of said release member abutting a surface of said first piston; and an outer end of said release member being provided with a tool-application portion for permitting manual rotation of said release member to cause displacement of said first piston in opposition to the preload of said actuator and, thereby releasing said parking brake system.

3. The parking brake system of claim 1, wherein said preloaded actuator takes the form of a strut assembly having an internal compression spring preloaded to a predetermined value.

4. The parking brake system of claim 3, wherein said strut assembly output member extends from both ends thereof, with an output member outer end being provided with adjustment and jam nuts as well as an attachment member for operative mechanical interconnection with said wheel brakes.

5. The parking brake system of claim 4, wherein an inner end of said output member includes a stepped portion that terminates within said first piston.

6. The parking brake system of claim 1, wherein said movement of said first piston, and consequently of said actuator output member, is sufficient to one of apply and release said parking brake system.

7. The parking brake system of claim 1, wherein the location of said Hall-Effect sensor with its built-in relay, within said main housing is spaced from an at-rest position of said first piston at a distance substantially corresponding with a predetermined length of movement of said first piston.

8. The parking brake system of claim 1, wherein the voltage of said electric power applied to said DC motor is in the range of about 12 to 42 volts.

9. The parking brake system of claim 1, further including a steel ring interposed between an inner end surface of said second cavity and said first piston.

10. The parking brake system of claim 1, wherein the specific vehicle to which said parking brake system is applied is a fork-lift truck.

11. The parking brake system of claim 1, wherein said preloaded actuator includes: a spring cylinder having a fully open lower end, a constricted upper end and an intermediate cavity; said movable output member extending from both ends thereof; said lower end being closed by a stepped cap; a second piston located within said cavity; and a compression spring, located within said cavity between an inner surface of said second piston and an inner surface of said spring cylinder constricted upper end.

12. The parking brake system of claim 11, wherein said compression spring is preloaded to a predetermined value.

13. The parking brake system of claim 11, wherein said first and second pistons are annular and are of differing diameters.

14. The parking brake system of claim 13, wherein said main housing second cavity is stepped and includes a smaller diameter inner bore, for housing said first piston, and a larger diameter outer bore for housing said second piston.

15. The parking brake system of claim 13, further including a bushing located intermediate said first and second pistons.

16. The parking brake system of claim 1, wherein said normally-open control valve is a rotary solenoid operated valve.

17. The parking brake system of claim 1, wherein said built-in relay of said Hall-Effect sensor includes bladed terminals.

18. The parking brake system of claim 1 further including an operator-controlled mechanism for actuating the system, said operator-controlled mechanism includes one of an operator-controlled switch, an operator-controlled transmission lever and an operator-actuated load cell in an operator seat.
